(19) United States
(12) Patent Application Publication
(10) Pub. No.: US 2025/0158121 A1
(43) Pub. Date: May 15, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Olga TSAY, Yongin-si (KR); SANGHOON KIM, Yongin-si (KR); TAE HYON BAE, Yongin-si (KR); Harim LEE, Yongin-si (KR); Youngkyeong SHIN, Yongin-si (KR); Seunghyeon SON, Yongin-si (KR); Sanghyung KIM, Yongin-si (KR)

(21) Appl. No.: 18/795,855

(22) Filed: Aug. 6, 2024

(30) Foreign Application Priority Data
Nov. 9, 2023 (KR) 10-2023-0154751

(51) Int. Cl. H01M 10/0567; H01M 10/0525; H01M 10/0569; H01M 10/0583; H01M 10/36

(52) U.S. Cl. CPC H01M 10/0567; H01M 10/0525; H01M 10/0569; H01M 10/0583; H01M 10/365; H01M 2300/0028

(57) ABSTRACT

A rechargeable lithium battery includes an electrolyte. The electrolyte comprises a non-aqueous organic solvent, a lithium salt, and an additive including an azide group and a sulfonyl group substituted with a halogen element.

### CROSS-REFERENCE TO RELATED APPLICATION

The present application claims priority to and the benefit of Korean Patent Application No. 10-2023-0154751, filed on Nov. 9, 2023, in the Korean Intellectual Property Office, the entire content of which is incorporated herein by reference.

### BACKGROUND

### 1. Field

Embodiments of the present disclosure described herein are related to an electrolyte for a rechargeable lithium battery and a rechargeable lithium battery including the same.

### 2. Description of the Related Art

Recently, with the rapid spread or development of battery utilizing electronic or electrical devices, such as mobile phones, laptop computers, and/or vehicles (e.g., electric vehicles), there is an increasing demand for rechargeable batteries with relatively high energy density and relatively high capacity. Therefore, research has been conducted to improve performance of such batteries, e.g., rechargeable lithium batteries.

A rechargeable lithium battery includes a positive electrode, a negative electrode, and an electrolyte. The positive electrode and the negative electrode each include an active material in which intercalation and deintercalation are possible, and generates electrical energy caused by oxidation and reduction reactions if (e.g., when) lithium ions are intercalated and deinterlated.

A lithium salt dissolved in a non-aqueous organic solvent is utilized as the electrolyte of the rechargeable lithium battery. The rechargeable lithium battery exhibits characteristics based on complex reactions between the positive electrode and the electrolyte and between the negative electrode and the electrolyte. Accordingly, the use of an appropriate or suitable electrolyte is an important area for improvement of the rechargeable lithium battery.

### SUMMARY

Aspects according to one or more embodiments are directed toward an electrolyte for a rechargeable lithium battery with improved lifetime and stability.

Aspects according to one or more embodiments are directed toward a rechargeable lithium battery including the electrolyte.

Additional aspects will be set forth in part in the description which follows and, in part, will be apparent from the description, or may be learned by practice of the presented embodiments of the present disclosure.

According to one or more embodiments of the present disclosure, an electrolyte for a rechargeable lithium battery may include: a non-aqueous organic solvent; a lithium salt; and an additive including an azide group and a sulfonyl group substituted with a halogen element.

According to one or more embodiments of the present disclosure, a rechargeable lithium battery may include: a positive electrode that includes a positive electrode active material; a negative electrode that includes a negative electrode active material; and an electrolyte. The electrolyte may include: a non-aqueous organic solvent; a lithium salt; and an additive including an azide group and a sulfonyl group substituted with a halogen element.

### BRIEF DESCRIPTION OF DRAWINGS

FIG. 1 illustrates a simplified conceptual diagram showing a rechargeable lithium battery according to one or more embodiments of the present disclosure.

FIGS. 2-5 illustrate simplified cross-sectional views showing a rechargeable lithium battery according to one or more embodiments of the present disclosure.

FIG. 6 illustrates a graph showing test results of lithium symmetric cells of rechargeable lithium batteries in accordance with Embodiment 3 and Comparative Example 1.

FIG. 7A illustrates a graph showing results of negative electrode cyclic voltammetry (CV) in accordance with Embodiment 3 and Comparative Example 1.

FIG. 7B illustrates a graph showing results of positive electrode cyclic voltammetry (CV) of electrolytes in accordance with Embodiment 3 and Comparative Example 1.

FIG. 8 illustrates a graph showing linear sweep voltammetry (LSV) evaluation results of Embodiment 3 and Comparative Example 1.

### DETAILED DESCRIPTION

In order to sufficiently understand the configuration and effect of the present disclosure, one or more embodiments of the present disclosure will be described with reference to the accompanying drawings. It should be noted, however, that the present disclosure is not limited to the following example embodiments, and may be implemented in one or more suitable forms. Rather, the example embodiments are provided only to disclose the present disclosure and let those skilled in the art fully know the scope of the present disclosure.

In this description, it will be understood that, if (e.g., when) an element is referred to as being on another element, the element can be directly on the other element or intervening elements may be present between therebetween. In the drawings, thicknesses of some components are exaggerated for effectively explaining the technical contents. Like reference numerals refer to like elements throughout, and duplicative descriptions thereof may not be provided the specification.

Unless otherwise specially noted in this description, the expression of singular form may include the expression of plural form. In addition, unless otherwise specially noted, the phrase “A or B” may indicate “A but not B”, “B but not A”, and “A and B”. The terms “comprises/includes” and/or “comprising/including” utilized in this description do not exclude the presence or addition of one or more other components.

As utilized herein, expressions such as “at least one of”, “one of”, and “of (e.g., selected from among)”, when preceding a list of elements, modify the entire list of elements and do not modify the individual elements of the list. For example, “at least one of a, b or c”, “at least one selected from among a, b and c”, and/or the like, may indicate only a, only b, only c, both (e.g., simultaneously) a and b, both (e.g., simultaneously) a and c, both (e.g., simultaneously) b and c, all of a, b, and c, or variations thereof.

The term utilized herein is intended to describe only a specific embodiment and is not intended to limit the present disclosure. As utilized herein, the singular forms “a,” “an,” and “the” are intended to include the plural forms, including “at least one,” unless the content (e.g., amount) clearly indicates otherwise. “At least one” should not be construed as being limited to the singular. As utilized herein, the term “and/or” includes any and all combinations of one or more of the associated listed items. The terms “includes,” “including,” “comprises,” and/or “comprising,” when utilized in the detailed description, specify a presence of stated features, regions, integers, steps, operations, elements, and/or components, but do not preclude the presence or addition of one or more other features, regions, integers, steps, operations, elements, components, and/or groups thereof.

Spatially relative terms such as “beneath,” “below,” “lower,” “above,” and “upper” may be utilized herein to easily describe one element or feature's relationship to another element or feature. It will be understood that the spatially relative terms are intended to encompass different orientations of a device in utilize or operation in addition to the orientation illustrated in the drawings. For example, when a device in the drawings is turned over, elements described as “below” or “beneath” other elements or features would then be “above” or “over” the other elements or features. In some embodiments, the example term “below” may encompass both (e.g., simultaneously) orientations of above and below. The device may be otherwise oriented (rotated 90 degrees or at other orientations), and the spatially relative terms utilized herein may be interpreted accordingly.

The term “metal” as utilized herein includes all of metals and metalloids such as silicon and germanium in an elemental or ionic state.

The term “alloy” as utilized herein refers to a mixture of two or more metals.

The term “electrode active material” as utilized herein refers to an electrode material that may undergo lithiation and delithiation.

The term “composite cathode active material” as utilized herein refers to a cathode material that may undergo lithiation and delithiation.

The term “anode active material” as utilized herein refers to an anode material that may undergo lithiation and delithiation.

The terms “lithiate” and “lithiating” as utilized herein refer to a process of adding lithium to an electrode active material.

The terms “delithiate” and “delithiating” as utilized herein refer to a process of removing lithium from an electrode active material.

The terms “charge” and “charging” as utilized herein refer to a process of providing electrochemical energy to a battery.

The terms “discharge” and “discharging” as utilized herein refer to a process of removing electrochemical energy from a battery.

The terms “positive electrode” and “cathode” as utilized herein refer to an electrode at which electrochemical reduction and lithiation occur during a discharging process.

The terms “negative electrode” and “anode” as utilized herein refer to an electrode at which electrochemical oxidation and delithiation occur during a discharging process.

As utilized herein, the term “substantially” and similar terms are utilized as terms of approximation and not as terms of degree, and are intended to account for the inherent deviations in measured or calculated values that would be recognized by those of ordinary skill in the art. Also, the term “about” and similar terms, when utilized herein in connection with a numerical value or a numerical range, are inclusive of the stated value and a value within an acceptable range of deviation for the particular value as determined by one of ordinary skill in the art, considering the measurement in question and the error associated with measurement of the particular quantity (e.g., the limitations of the measurement system). For example, “about” may refer to within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As utilized herein, “a combination thereof” may refer to a mixture of constituents, a stack, a composite, a copolymer, an alloy, a blend, and a reaction product.

As utilized herein, if (e.g., when) a definition is not otherwise provided, in chemical formulae, hydrogen is bonded at the position if (e.g., when) a chemical bond is not drawn where supposed to be given. As utilized herein, the term “combination thereof” may refer to a mixture, a stack, a composite, a copolymer, an alloy, a blend, or a reaction product.

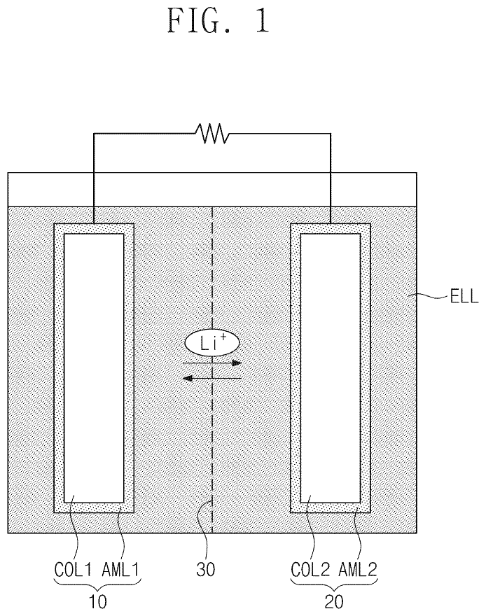

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and further include a binder and/or a conductive material.

For example, the positive electrode 10 may further include an additive that can serve as a sacrificial positive electrode.

An amount of the positive electrode active material may range from about 90 wt % to about 99.5 wt % based on about 100 wt % of the positive electrode active material layer AML1. Amounts of the binder and the conductive material may be about 0.5 wt % to about 5 wt % based on about 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may be utilized to provide an electrode with conductivity, and any suitable conductive material without causing chemical change of a battery may be utilized as the conductive material to constitute the battery. The conductive material may include, for example, a carbon-based material such as natural graphite, artificial graphite, carbon black, acetylene black, Ketjen black, carbon fiber, carbon nano-fiber, and carbon nano-tube; a metal powder or metal fiber containing one or more selected from among copper, nickel, aluminum, and silver; a conductive polymer such as a polyphenylene derivative; and/or a mixture thereof (e.g., a suitable mixture thereof).

Al may be utilized as the current collector COL1, but the present disclosure is not limited thereto.

### Positive Electrode Active Material

The positive electrode active material may include a compound (e.g., lithiated intercalation compound) that can reversibly intercalate and de-intercalate lithium. For example, the positive electrode active material may include at least one kind of composite oxide including lithium and metal that is selected from among cobalt, manganese, nickel, and/or a combination thereof (e.g., a suitable combination thereof).

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, and/or a combination thereof (e.g., a suitable combination thereof).

For example, the positive electrode active material may include a compound expressed by one selected from among chemical formulae: LiₐA_{1-b}X_{b}O_{2-c}D_{c} (0.90≤a≤1.8, 0≤b≤0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}Co_{b}X_{c}O_{2-α}D_{α} (0.90≤a≤1.8, 0≤b≤0.5, 0≤c≤0.5, 0<α<2), LiₐNi_{1-b-c}Mn_{b}X_{c}O_{2-α}D_{α} (0.90≤a≤1.8, 0≤b≤0.5, 0≤c≤0.5, 0<α<2), LiₐNi_{b}Co_{c}L¹_{d}GeO₂ (0.90≤a≤1.8, 0≤b≤0.9, 0≤c≤0.5, 0≤d≤0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}G_{b}O₂ (0.90≤a≤1.8, 0.001≤b≤0.1), LiₐMn₂G_{b}O₄ (0.90≤a≤1.8, 0.001≤b≤0.1), LiₐMn_{1-g}G_{g}PO₄ (0.90≤a≤1.8, 0≤g≤0.5), Li_{(3-f)}Fe₂(PO₄)₃ (0≤f≤2), and LiₐFePO₄ (0.90≤a≤1.8).

In the chemical formulae above, A is Ni, Co, Mn, and/or a combination thereof (e.g., a suitable combination thereof), X is Al, Ni, Co, Mn, Cr, Fe, Mg, Sr, V, a rare element, and/or a combination thereof (e.g., a suitable combination thereof), D is O, F, S, P, and/or a combination thereof (e.g., a suitable combination thereof), G is Al, Cr, Mn, Fe, Mg, La, Ce, Sr, V, and/or a combination thereof (e.g., a suitable combination thereof), and L¹ is Mn, Al, and/or a combination thereof (e.g., a suitable combination thereof).

For example, the positive electrode active material may be a high nickel-based positive electrode active material having a nickel content (e.g., amount) of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % based on about 100 mol % of metal devoid of lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material (e.g., electron conductor).

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, and/or a combination thereof (e.g., any suitable combination thereof).

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, and/or a combination thereof (e.g., any suitable combination thereof).

The aqueous binder may include styrene-butadiene rubber, (meth)acrylated styrene-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, and/or a combination thereof (e.g., any suitable combination thereof).

When an aqueous binder is utilized as the negative electrode binder, a cellulose-based compound capable of providing viscosity may further be included. The cellulose-based compound may include one or more selected from among carboxymethyl cellulose, hydroxypropylmethyl cellulose, methyl cellulose, and alkali metal salts thereof. The alkaline metal may include Na, K, or Li.

The dry binder may include a fibrillizable polymer material, for example, polytetrafluoroethylene, polyvinylidene fluoride, polyvinylidene fluoride-hexafluoropropylene copolymer, polyethylene oxide, and/or a combination thereof (e.g., any suitable combination thereof).

The conductive material (e.g., electron conductor) may be utilized to provide an electrode with conductivity, and any suitable conductive material without causing chemical change of a battery may be utilized as the conductive material to constitute the battery. For example, the conductive material may include a carbon-based material such as natural graphite, artificial graphite, carbon black, acetylene black, Ketjen black, carbon fiber, carbon nano-fiber, and carbon nano-tube; a metal powder or metal fiber including one or more selected from among copper, nickel, aluminum, and silver; a conductive polymer such as a polyphenylene derivative; and/or a mixture thereof (e.g., any suitable mixture thereof).

The current collector COL2 may include a copper foil, a nickel foil, a stainless steel foil, a titanium foil, a nickel foam, a copper foam, a polymer substrate coated with a conductive metal, and/or a combination thereof (e.g., a suitable combination thereof).

### Negative Electrode Active Material

The negative electrode active material may include a material that can reversibly intercalate and de-intercalate lithium ions, lithium metal, a lithium metal alloy, a material that can dope and de-dope lithium, or transition metal oxide.

The material that can reversibly intercalate and de-intercalate lithium ions may include a carbon-based negative electrode active material, for example, crystalline carbon, amorphous carbon, and/or a combination thereof (e.g., any suitable combination thereof). For example, the crystalline carbon may include graphite such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is selected from among Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include silicon, silicon-carbon composite, SiOx (0<x≤2), Si-Q alloy (where Q is alkali metal, alkaline earth metal, element of Group 13, element of Group 14 (except for Si), element of Group 15, element of Group 16, transition metal, rare-earth element, and/or a combination thereof (e.g., any suitable combination thereof), and/or a combination thereof (e.g., any suitable combination thereof). The Sn-based negative electrode active material may include Sn, SnOx (0<x≤2) (e.g., SnO₂), a Sn-based alloy, a combination thereof.

The silicon-carbon composite may be a composite of silicon and amorphous carbon. According to one or more embodiments, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material or the Sn-based negative electrode active material may be utilized in combination with a carbon-based negative electrode active material.

### Separator 30

Based on type or kind of the rechargeable lithium battery, the separator 30 may be present between positive electrode 10 and the negative electrode 20. The separator 30 may include one or more selected from among polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, and/or a combination thereof (e.g., any suitable combination thereof).

The porous substrate may be a polymer layer including one selected from among polyolefin such as polyethylene and polypropylene, polyester such as polyethylene terephthalate and/or polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including two or more of the materials mentioned above.

The organic material may include a polyvinylidenefluoride-based copolymer or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a combination thereof (e.g., any suitable combination thereof), but the present disclosure is not limited thereto.

The organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium for transmitting ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, and/or a combination thereof (e.g., any suitable combination thereof).

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, or caprolactone.

The ether-based solvent may include dibutyl ether, tetraglyme, diglyme, dimethoxyethane, 2-methyltetrahydrofuran, 2.5-dimethyltetrahydrofuran, or tetrahydrofuran. The keytone-based solvent may include cyclohexanone. The aprotic solvent may include nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be utilized alone or in a mixture of two or more substances.

In addition, if (e.g., when) a carbonate-based solvent is utilized, a cyclic carbonate and a chain carbonate may be mixed and utilized, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium tetrafluoroethanesulfonate, lithium difluorobis(oxalato)phosphate (LiDFOB), and lithium bis(oxalato) borate (LiBOB)

### Rechargeable Lithium Battery

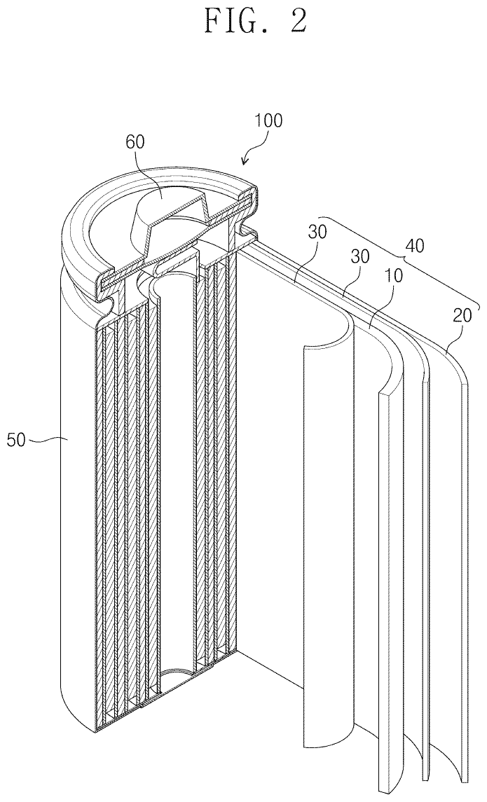

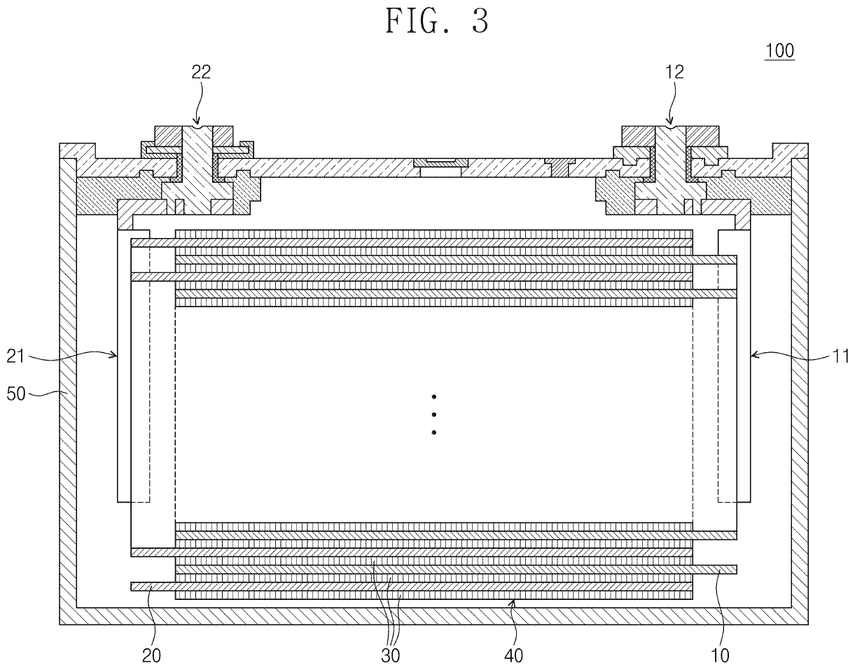

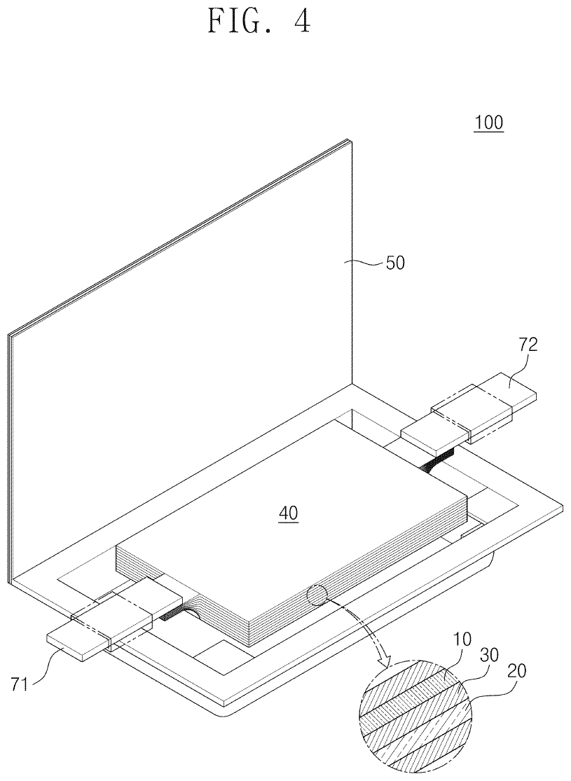

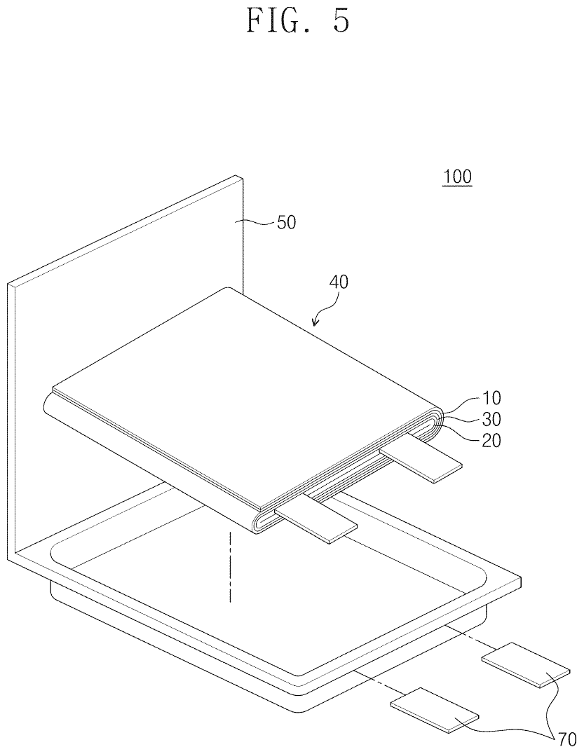

Based on shape of a rechargeable lithium battery, the rechargeable lithium battery may be classified into cylindrical, prismatic, pouch, and coin types (kinds). FIGS. 2 to 5 illustrate simplified diagrams showing a rechargeable lithium battery according to one or more embodiments. FIG. 2 shows a cylindrical battery, FIG. 3 shows a prismatic battery, and FIGS. 4 and 5 show pouch-type or kind batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte. The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70, or a positive electrode tab 71 and a negative electrode tab 72, which serves as an electrical path for externally inducing a current generated in the electrode assembly 40.

The following will describe in more detail an electrolyte of a rechargeable lithium battery according to one or more embodiments of disclosure.

An electrolyte for a rechargeable lithium battery according to one or more embodiments may include a non-aqueous organic solvent, a lithium salt, and an additive including an azide group and a sulfonyl group substituted with a halogen element.

The electrolyte may be manufactured by a mixing process in which the salt is dissolved in the non-aqueous organic solvent and the additive is added to mix. The electrolyte mixing process may include any suitable processes in electrolyte fabrication field, and a person skilled in the art will be able to appropriately or suitably select and utilize.

In one or more embodiments, a rechargeable lithium battery may be provided which includes a positive electrode including a positive electrode active material, a negative electrode including a negative electrode active material, and an electrolyte, which the electrolyte may include a non-aqueous organic solvent, a lithium salt, and an additive including an azide group and a sulfonyl group substituted with a halogen element.

The non-aqueous organic solvent may include at least one selected from among ethylene carbonate (EC), propylene carbonate (PC), propyl propionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

The non-aqueous organic solvent may be, for example a mixture solvent of ethylene carbonate (EC), propyl carbonate (PC), and propyl propionate (PP).

For example, the ethylene carbonate (EC) may be included at about 5 vol % to about 20 vol % based on the total volume of the non-aqueous organic solvent. The propylene carbonate (PC) may be included at about 10 vol % to about 30 vol % based on the total volume of the non-aqueous organic solvent. The propylene carbonate (PC) may be included at about 50 vol % to about 80 vol % based on the total volume of the non-aqueous organic solvent.

For example, the lithium salt may include LiPF₆.

The lithium salt may have a concentration of about 0.1 M to about 2.0 M. For example, the lithium salt may have a concentration of equal to or greater than about 0.5 M or about 1.0 M. The lithium salt may have a concentration of equal to or less than about 2.0 M, equal to or less than about 1.7 M, or equal to or less than about 1.5 M. In the present disclosure, if (e.g., when) the lithium salt has a concentration of about 0.1 M to about 2.0 M, the electrolyte may appropriately or suitably maintain its conductivity and viscosity.

The additive may be a compound including an azide group and a sulfonyl group substituted with a halogen element. The azide group and the sulfonyl group substituted with a halogen element may allow that a lithium salt-based solid electrolyte interface (SEI) film is formed on a surface of a negative or positive electrode, and thus it may be possible to decrease an interfacial resistance between the positive electrode and the electrolyte, to accelerate movement of lithium ions on the surface of the positive electrode, and to suppress or reduce decomposition of a negative or positive electrode active material. For example, as will be ascertained in Evaluations discussed herein, the additive may be reduced to the non-aqueous organic solvent to form a lithium salt-based solid electrolyte interface (SEI) film on the surface of the negative or positive electrode, which may accomplish passivation.

The additive may be included in an amount of about 0.02 wt % to about 2.0 wt % based on the total amount of the electrolyte. For example, the additive may be included in an amount of about 0.1 wt % to about 1.5 wt % based on the total weight of (100 wt % of) the electrolyte. The additive may be included in an amount of about 0.5 wt % to about 1.0 wt % based on the total weight of the electrolyte. When the additive has the aforementioned concentration in the electrolyte, a protective film having appropriate or suitable film resistance may be formed on an electrode surface of a lithium battery to improve cycle characteristics of the lithium battery.

The additive according to one or more embodiments of the present disclosure may be represented by Chemical Formula 1.

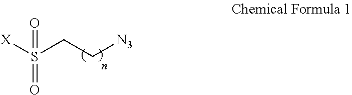

In Chemical Formula 1, n may be an integer between 1 and 5, and X may be a halogen element. The halogen element may include fluorine, bromine, chlorine, iodine, and so forth.

For example, in an electrolyte for a rechargeable lithium battery according to the present disclosure, the additive may be represented by Chemical Formula 1-1.

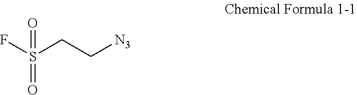

The additive in accordance with Chemical Formula 1-1 may have a compound structure including an azide group and a sulfonyl group substituted with a fluorine element, which azide and sulfonyl groups act as a functional group.

For example, as the additive has a structure including both (e.g., simultaneously) of an azide group and a sulfonyl group substituted with a fluorine element, a lithium salt-based solid electrolyte interface (SEI) film may be maintained on the surface of the negative or positive electrode, and mobility of lithium ions may be increased to improve stability and cycle-life characteristics of lithium batteries.

In a rechargeable lithium battery utilizing an electrolyte according to the present disclosure, a positive electrode active material may include one or more selected from among lithium cobalt-based oxide, lithium nickel-based oxide, lithium manganese-based oxide, lithium iron phosphate-based compounds, cobalt-free nickel-manganese-based oxide, and any combination thereof. For example, the positive electrode active material may include lithium cobalt-based oxide.

In a rechargeable lithium battery utilizing an electrolyte according to the present disclosure, a negative electrode active material may include a carbon-based negative electrode active material, a silicon-based negative electrode active material, or any combination thereof.

A rechargeable lithium battery according to one or more embodiments of the present disclosure may be applied to automotive vehicles, mobile phones, and/or any other electrical devices, but the present disclosure is not limited thereto.

The following will describe Examples/Embodiments and Comparative Examples of the present disclosure. The following examples/embodiments are only one or more embodiments/examples of the present disclosure, and the present disclosure is not limited to the following embodiments/examples.

### EMBODIMENTS AND COMPARATIVE EXAMPLES

### Embodiment 1

### (1) Fabrication of Electrolyte

LiPF₆ of about 1.3 M was dissolved in a nonaqueous organic solvent in which ethylene carbonate (EC), propylene carbonate (PC), propyl propionate (PP) are mixed in a volume ratio of about 10:15:75, and an additive of about 0.2 wt % was added to fabricate an electrolyte.

A material represented by Chemical Formula 1-1 was utilized as the additive.

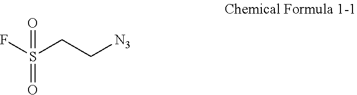

For example, the additive in accordance with Chemical Formula 1-1 may be fabricated from the following Synthesis Example.

### Synthesis Example 1

First, sodium azide (about 4 g) was added after 2-chloroethanesulfonyl fluoride (about 9 g) was dissolved in dimethyl sulfoxide (DMSO) (about 25 mL), and the mixture was agitated at room temperature (about 25° C.) for about 12 hours to manufacture a reaction mixture. Afterwards, the reaction mixture was diluted with cold water (about 180 mL) and then extracted with ethyl acetate. Thereafter, a filtered organic layer was washed with brine, dried with Na₂SO₄, concentrated under reduced pressure, and then purified with column chromatography to obtain 2-azidoethane-1-sulfonyl fluoride, or a compound represented by Chemical Formula 1-1.

### (2) Fabrication of Rechargeable Lithium Battery

LiCoO₂ (LCO) of about 97 wt %, artificial graphite powder of about 0.5 wt % as a conductive material, carbon black (Ketjen black) of about 0.8 wt %, acrylonitrile rubber of about 0.2 wt %, and polyvinylidene fluoride (PVdF) of about 1.5 wt % were mixed and added to N-methyl-2-pyrrolidone, and then were stirred for about 30 minutes by utilizing a mechanical agitator to manufacture slurry of positive electrode active material. A doctor blade was utilized to coat the slurry with a thickness of about 60 μm on an aluminum current collector of about 20 μm, dried in a hot-air drier at about 100° C. for about 0.5 hours, dried again at a condition of vacuum and at about 120° C. for about 4 hours, and then roll-pressed to manufacture a positive electrode.

Artificial graphite of about 98 wt %, styrene-butadiene rubber (SBR) of about 1 wt %, and carboxymethyl cellulose (CMC) of about 1 wt % were mixed and added to distilled water, and then stirred for about 60 minutes by utilizing a mechanical agitator to manufacture slurry of negative electrode active material. A doctor blade was utilized to coat the slurry with a thickness of about 60 μm on a copper current collector of about 10 μm, dried in a hot-air drier at about 100° C. for about 0.5 hours, dried again at a condition of vacuum and at about 120° C. for about 4 hours, and then roll-pressed to manufacture a negative electrode.

The slurry of negative electrode active material was coated on a copper (Cu) foil with a thickness of about 10 μm, dried at about 100° C., and then pressed to manufacture a negative electrode.

The positive electrode, the negative electrode, and a polyethylene separator having a thickness of about 10 μm were assembled to manufacture an electrode assembly, and the electrolyte manufactured by the method above was introduced to fabricate a rechargeable lithium battery.

### Embodiment 2

An electrolyte and a rechargeable lithium battery were fabricated by same method as that of Embodiment 1, except that the additive of about 0.5 wt % was applied.

### Embodiment 3

An electrolyte and a rechargeable lithium battery were fabricated by same method as that of Embodiment 1, except that the additive of about 1.0 wt % was applied.

### Embodiment 4

An electrolyte and a rechargeable lithium battery were fabricated by same method as that of Embodiment 1, except that the additive of about 2.0 wt % was applied.

### Comparative Example 1

An electrolyte and a rechargeable lithium battery were fabricated by the same method as that of Embodiment 1, except that the additive expressed by Chemical Formula 1-1 was utilized if (e.g., when) the electrolyte was manufactured.

### Comparative Example 2

An electrolyte and a rechargeable lithium battery were fabricated by the same method as that of Embodiment 3, except that a compound expressed by Chemical Formula 2 was utilized instead of a compound represented by Chemical Formula 1-1 as an electrolyte additive.

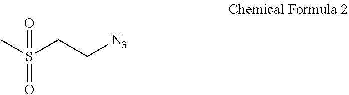

### Comparative Example 3

An electrolyte and a rechargeable lithium battery were fabricated by the same method as that of Embodiment 3, except that a compound represented by Chemical Formula 3 was utilized instead of a compound represented by Chemical Formula 1-1 as an electrolyte additive.

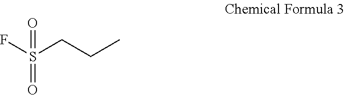

### Evaluation Example

A rechargeable lithium battery was evaluated by the following method.

### Evaluation 1: Charge/Discharge Cycle Characteristics

The rechargeable lithium batteries prepared in Embodiments and Comparative Examples were each charged at about 25° C. with a constant current at about 0.2 C rate until a voltage was about 4.53 V (vs. Li), and then the current was cut-off at about 0.05 C rate while a voltage was maintained at about 4.3 V in a constant voltage mode. Then, the battery was discharged with a constant current of about 0.2 C rate until a voltage was about 2.5 V (vs. Li) (formation process).

A high-temperature charge/discharge characteristics evaluation was conducted on the rechargeable lithium batteries that had undergone the formation process. The rechargeable lithium batteries were each charged and discharged at about 45° C. for 100 cycles under the condition of charge (about 1.5 C/4.5V, about 0.05 C Cut-off, Rest about 10 min.) and discharge (about 0.5 C/3.0V Cut-off, Rest about 10 min.).

After an initial discharge capacity and a post-100-cycle discharge capacity were measured, a capacity retention rate was calculated and results thereof were listed in Table 1. The capacity retention rate was calculated according to Equation 1.

$$Capacity retention rate ( \% ) = \qquad Equation 1$$

$$( discharge capacity after 100 cycles / initial discharge capacity ) \times 100$$

TABLE 1

| | Initial | Discharge capacity | Capacity retention |
|---|---|---|---|
| | discharge | after 100 cycles | rate after 100 |
| | capacity (mAh) | (mAh) | cycles (%) |
| Embodiment 1 | 5.28 | 4.52 | 85.6 |
| Embodiment 2 | 5.26 | 4.54 | 86.3 |
| Embodiment 3 | 5.26 | 4.58 | 87.0 |
| Embodiment 4 | 5.32 | 4.46 | 83.8 |
| Comparative | 5.25 | 4.32 | 82.3 |
| Example 1 | | | |
| Comparative | 5.27 | 4.29 | 81.4 |
| Example 2 | | | |
| Comparative | 5.32 | 4.55 | 85.5 |
| Example 3 | | | |

### Evaluation 2: Lithium Dendrite Characteristics

The electrolytes utilized in Embodiment 3 and Comparative Example 1 were utilized to fabricate Li/Li symmetric 2032-type or kind coin cells.

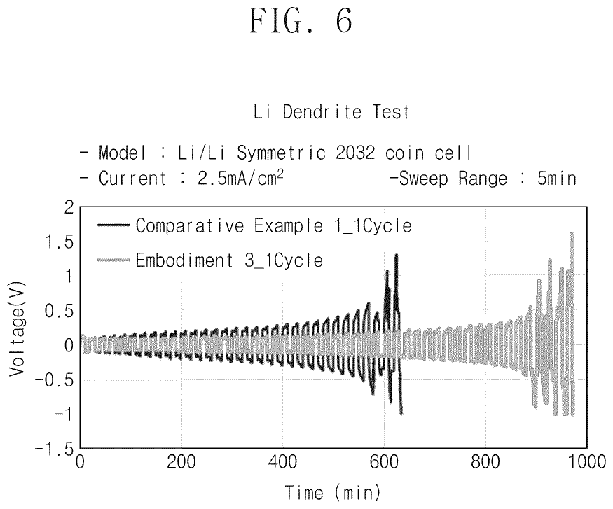

A lithium symmetric cell test was executed to ascertain lithium dendrite characteristics, and results thereof were shown FIG. 6. FIG. 6 illustrates a graph showing test results of lithium symmetric cells of rechargeable lithium batteries in accordance with Embodiment 3 and Comparative Example 1. The lithium symmetric cell test was performed at a condition of current of about 2.5 mA/cm² and sweep range of about 5 minutes.

### Evaluation 3: CV Characteristics

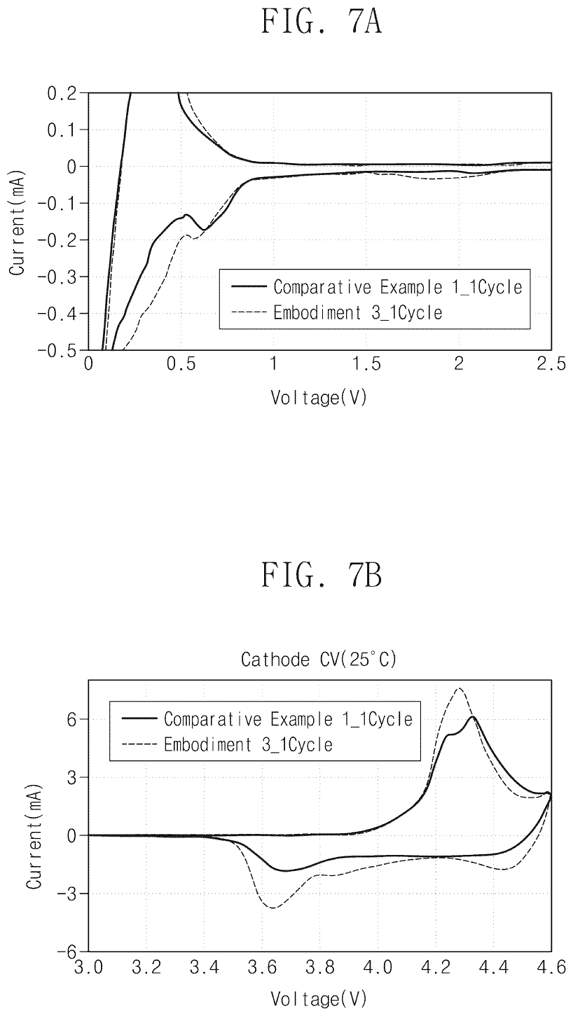

A cyclic voltammetry (CV) was performed at room temperature (about 25° C.) to evaluate electrochemical stability of the electrolytes utilized in Embodiment 3 and Comparative Example 1, and results thereof were shown FIGS. 7A and 7B. FIG. 7A illustrates a graph showing results of negative electrode cyclic voltammetry (CV) in accordance with Embodiment 3 and Comparative Example 1. FIG. 7B illustrates a graph showing results of positive electrode cyclic voltammetry (CV) of electrolytes in accordance with Embodiment 3 and Comparative Example 1.

A negative CV measurement was performed by suing a coin half-cell in which a graphite negative electrode is utilized as a working electrode and Li metal is utilized as a counter electrode. In this case, a scanning was performed from about 3 V to about 0 V for 3 cycles, a scanning speed was about 0.1 mV/sec.

A positive CV measurement was performed by suing a cathode coin half-cell in which an LCO positive electrode is utilized as a working electrode and Li metal is utilized as a counter electrode. In this case, scanning was performed from about 3 V to about 4.6 V for 3 cycles, a scanning speed was about 0.1 mV/sec.

### Evaluation 4: Linear Sweep Voltammetry (LSV) Characteristics of Batteries

For the electrolytes prepared by Embodiment 3 and Comparative Example 1, a linear sweep voltammetry (LSV) at room temperature (about 25° C.) was utilized to evaluate oxidation electrode decomposition.

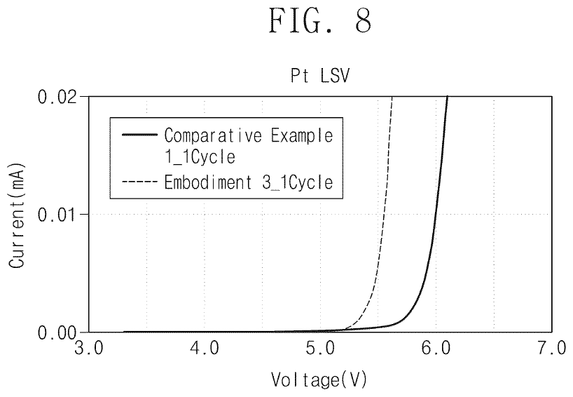

A three-electrode beaker cell was utilized in which a Pt electrode is utilized as a working electrode and Li metal is utilized as a counter electrode and a reference electrode. In this case, scanning was performed at a rate of about 1 mV/sec in a range of about 3.0 V to about 7.0 V. FIG. 8 illustrates a graph showing LSV evaluation results of Embodiment 3 and Comparative Example 1.

### Comprehensive Evaluation

Referring to Table 1, without being bound by any particular theory, it was ascertained that there was an improvement in capacity retention rate depending on the charge/discharge cycle in cases (Embodiments 1 to 4) each utilizing an electrolyte that includes an additive according to the present disclosure in comparison with a case (Comparative Example 1) utilizing an electrolyte to which no additive is added at all.

Without being bound by any particular theory, it was ascertained that there was an improvement in capacity retention rate depending on the charge/discharge cycle in cases (Embodiments 1 to 4) each utilizing an electrolyte that includes an additive according to the present disclosure in comparison with cases (Comparative Examples 2 and 3) each utilizing an electrolyte that includes none of functional groups such as an azide group and a sulfonyl group substituted with a halogen element.

Referring to FIG. 6, without being bound by any particular theory, it was ascertained that the rechargeable lithium battery of Embodiment 3 had a lifetime superior to that of the rechargeable lithium battery of Comparative Example 1. Therefore, without being bound by any particular theory, it is believed that addition of an additive according to the present disclosure to an electrolyte will help suppress or reduce the formation of lithium dendrites on a surface of a negative electrode. Referring to FIGS. 7A and 7B, it may be seen that an additive according to one or more embodiments causes the formation of a film on the surface of the negative or positive electrode to accomplish passivation. For example, referring to FIG. 7A, without being bound by any particular theory, it was ascertained that the electrolyte in accordance with Comparative Example 1 exhibits a reduction decomposition peak at a low potential compared to the electrolyte in accordance with Embodiment 3. Thus, without being bound by any particular theory, it is believed that the electrolyte in accordance with Embodiment 3 causes the formation of an initial SEI film on a negative electrode over a wide voltage range before the occurrence of solvent decomposition during a charge procedure in which lithium ions are intercalated into the negative electrode.

Referring to FIG. 8, the additive may be preferentially oxidized to an organic solvent that forms a protective layer on a surface of a positive electrode, and the protective layer may more effectively suppress or reduce direct contact between the organic solvent and the positive electrode, which may result in more improvement in reversibility of intercalation/deintercalation of lithium ions. Thus, the additive may effectively contribute to stability and cycle life characteristics of a lithium battery.

As the electrolyte according to one or more embodiments uses the additive including an azide group and a sulfonyl group substituted with a halogen element and without being bound by any particular theory, it should exhibit an effect of an improvement in stability and lifetime characteristics at high-voltage conditions if (e.g., when) a rechargeable battery is activated.

In present disclosure, “not include a or any ‘component’”, “exclude a or any ‘component’”, “‘component’-free”, and/or the like refers to that the “component” not being added, selected or utilized as a component in the composition or compound, but the “component” of less than a suitable amount may still be included due to other impurities and/or external factors.

A battery management system (BMS) device, and/or any other relevant devices or components according to embodiments of the present disclosure described herein may be implemented utilizing any suitable hardware, firmware (e.g. an application-specific integrated circuit), software, or a combination of software, firmware, and hardware. For example, the one or more suitable components of the device may be formed on one integrated circuit (IC) chip or on separate IC chips. Further, the one or more suitable components of the device may be implemented on a flexible printed circuit film, a tape carrier package (TCP), a printed circuit board (PCB), or formed on one substrate. Further, the one or more suitable components of the device may be a process or thread, running on one or more processors, in one or more computing devices, executing computer program instructions and interacting with other system components for performing the one or more suitable functionalities described herein. The computer program instructions are stored in a memory which may be implemented in a computing device utilizing a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of one or more suitable computing devices may be combined or integrated into a single computing device, or the functionality of a particular computing device may be distributed across one or more other computing devices without departing from the scope of the present disclosure.

In present disclosure, “not include a or any ‘component’” “exclude a or any ‘component’”, “‘component’-free”, and/or the like refers to that the “component” not being added, selected or utilized as a component in the composition/structure, but the “component” of less than a suitable amount may still be included due to other impurities and/or external factors.

While this disclosure has been described in connection with what is presently considered to be embodiments, it is to be understood that the present disclosure is not limited to the disclosed embodiments and is intended to cover one or more suitable modifications and equivalent arrangements included within the spirit and scope of the appended claims, equivalents thereof, and therefore the aforementioned embodiments should be understood to be examples but not limiting this disclosure in any way.

What is claimed is:

1. An electrolyte comprising:
a non-aqueous organic solvent;
a lithium salt; and
an additive comprising an azide group and a sulfonyl group substituted with a halogen element,
wherein the electrolyte is for a rechargeable lithium battery.

2. The electrolyte as claimed in claim 1, wherein the additive is represented by Chemical Formula 1, 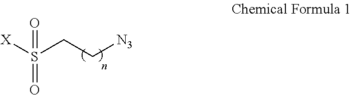
wherein in Chemical Formula 1,
n is an integer between 1 and 5, and
X is the halogen element.

3. The electrolyte as claimed in claim 1, wherein the additive is represented by Chemical Formula 1-1,

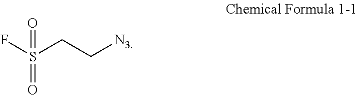

4. The electrolyte as claimed in claim 1, wherein the additive has about 0.02 wt % to about 2 wt % based on a total weight of the electrolyte.

5. The electrolyte as claimed in claim 1, wherein the non-aqueous organic solvent comprises one or more selected from among ethylene carbonate (EC), propylene carbonate (PC), propyl propionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

6. The electrolyte as claimed in claim 1, wherein the lithium salt comprises one or more selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), and LiC₄F₉SO₃.

7. The electrolyte as claimed in claim 1, wherein a concentration of the lithium salt is in a range of about 0.1 M to about 2.0 M.

8. A rechargeable lithium battery, comprising:
a positive electrode that comprises a positive electrode active material;
a negative electrode that comprises a negative electrode active material; and
the electrolyte as claimed in claim 1.

9. The rechargeable lithium battery as claimed in claim 8, wherein the positive electrode active material comprises one or more selected from among lithium cobalt-based oxide, lithium nickel-based oxide, lithium manganese-based oxide, lithium iron phosphate-based compounds, cobalt-free nickel-manganese-based oxide, and combinations thereof.

10. The rechargeable lithium battery as claimed in claim 8, wherein the negative electrode active material comprises a carbon-based negative electrode active material, a silicon-based negative electrode active material, or a combination thereof.
